(19) United States
(12) Patent Application Publication
(10) Pub. No.: US 2011/0067933 A1
(43) Pub. Date: Mar. 24, 2011

(54) TOUCH-CONTROL APPARATUS

(75) Inventors: Sean CHANG, Taoyuan Hsien (TW); Chii-How CHANG, Taoyuan Hsien (TW)

(73) Assignee: Delta Electronics, Inc.

(21) Appl. No.: 12/562,816

(22) Filed: Sep. 18, 2009

(51) Int. Cl. G06F 3/045

(52) U.S. Cl. 178/18.05

(57) ABSTRACT

A touch-control apparatus includes a touch-control unit, a sensing unit and an auxiliary voltage supplying unit. The touch-control unit has a touch-control substrate and at least one touch-control electrode layer, which is disposed on a surface of the touch-control substrate. The sensing unit is connected with the touch-control electrode layer of the touch-control unit and outputs a charging signal according to a power signal. The auxiliary voltage supplying unit outputs an auxiliary charging signal to a sensing conductive bar of the touch-control electrode layer, so that the sensing efficiency of the touch-control apparatus can be improved due to the auxiliary charging signal.

### BACKGROUND OF THE INVENTION

1. Field of Invention

The present invention relates to a touch-control apparatus.

2. Related Art

Recently, the multi-media messages (MMS) are widely used, so the inquiring function for them is indispensable. In the latest electronic devices, the touch screen is adopted to replace the conventional input tools such as the mouse and keyboard. This is because the touch screen is an easy operated, human friendly and space saving input tool. In fact, the touch screen has been widely used in many applications, such as the tour guide system, automatic teller machine (ATM), personal digital assistant (PDA), mobile phone, notebook computer, point-on-sale (POS) terminal, and industrial control system (ICS).

FIG. 1 is a schematic view of a conventional touch-control apparatus 1, which includes a touch-control unit 11 and a sensing unit 12. The sensing unit 11 has a touch-control substrate 111, at least one touch-control electrode layer 112, an insulation layer 113 and an electrical shielding layer 114. As shown in FIG. 1, the touch-control electrode layer 112 is disposed between the touch-control substrate 111 and the insulation layer 113, and the insulation layer 113 is disposed between the touch-control electrode layer 112 and the electrical shielding layer 114. The sensing unit 12 is electrically connected with the touch-control electrode layer 112 of the touch-control unit 11 for reading the voltage of an end A of the touch-control electrode layer 112. Then, the read voltage is compared with a reference voltage to determine whether the touch-control apparatus 1 is pressed.

FIG. 2 is a waveform diagram of the conventional touch-control apparatus 1. Referring to FIGS. 1 and 2, during a sensing period, the touch-control apparatus 1 charges the capacitances of the sensing conductive bars in the touch-control electrode layer 112 to a reference voltage V2 in advance, and then performs the sensing procedure to determine whether the touch-control apparatus 1 is pressed or not by the way of reading the voltages of the capacitances. However, as shown in FIG. 2, the conventional touch-control apparatus 1 can not charge the capacitances of the sensing conductive bars to the reference voltage V2 during the sensing period. In other words, the time period t1 for charging the capacitances to the reference voltage V2 is too long, so that the sensing procedure may be failed and the sensing efficiency is poor. Therefore, it is an important object of the present invention to provide a touch-control apparatus with enhanced sensing efficiency.

### SUMMARY OF THE INVENTION

In view of the foregoing, an object of the present invention is to provide a touch-control apparatus having the enhanced sensing efficiency.

To achieve the above, the present invention discloses a touch-control apparatus including a touch-control unit, a sensing unit and an auxiliary voltage supplying unit. The touch-control unit includes a touch-control substrate and at least one touch-control electrode layer, which is disposed on a surface of the touch-control substrate. The sensing unit is connected with the touch-control electrode layer of the touch-control unit and outputs a charging signal to a sensing conductive bar of the touch-control electrode layer according to a power signal. The auxiliary voltage supplying unit is electrically connected with the sensing unit and the touch-control electrode layer of the touch-control unit for outputting an auxiliary charging signal to the sensing conductive bar.

In one embodiment of the invention, the auxiliary charging signal is a DC signal.

In one embodiment of the invention, the charging signal is a DC signal.

In one embodiment of the invention, the auxiliary voltage supplying unit includes a resistor electrically connected with the sensing unit and the touch-control electrode layer.

In one embodiment of the invention, the auxiliary voltage supplying unit further includes an amplifier coupled with the resistor.

In one embodiment of the invention, the auxiliary voltage supplying unit and the sensing unit provide the auxiliary voltage signal and the charging signal, respectively and simultaneously, to the sensing conductive bar.

In one embodiment of the invention, the auxiliary charging signal provides a pre-determined level to the sensing conductive bar.

In addition, the present invention also discloses a detecting method of a touch-control apparatus, which includes a touch-control unit, a sensing unit and an auxiliary voltage supplying unit. The detecting method includes the following steps of: outputting a charging signal to a sensing conductive bar of a touch-control electrode layer of the touch-control unit according to a power signal by the sensing unit; outputting an auxiliary charging signal to the sensing conductive bar by the auxiliary voltage supplying unit; and reading a voltage of an end of the sensing conductive bar by the sensing unit.

In one embodiment of the invention, the detecting method further includes the following steps of: transmitting the read voltage to an input terminal of a comparator, and comparing the read voltage and a reference voltage by the comparator so as to output a signal to a timer.

In one embodiment of the invention, the auxiliary voltage supplying unit and the sensing unit provide the auxiliary voltage signal and the charging signal, respectively and simultaneously, to the sensing conductive bar.

In one embodiment of the invention, the step of outputting the auxiliary charging signal to the touch-control electrode layer by the auxiliary voltage supplying unit is prior to the step of outputting the charging signal to the sensing conductive bar.

As mentioned above, the touch-control apparatus of the present invention has a sensing unit for outputting the charging signal to the sensing conductive bar of the touch-control electrode layer of the touch-control unit and an auxiliary voltage supplying unit for outputting the auxiliary charging signal to the sensing conductive bar. Thus, the capacitances of the sensing conductive bar can reach the desired reference voltage much faster. Then, the sensing unit can determine whether the touch-control apparatus is pressed according to the charging time. Accordingly, the touch-control apparatus of the present invention can increase the charging speed of the capacitances of the sensing conductive bar, so that the sensing efficiency of the touch-control apparatus can be enhanced.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic view of a conventional touch-control apparatus;

FIG. 2 is a waveform of the conventional touch-control apparatus;

FIG. 3 is a schematic view of a touch-control apparatus according to an embodiment of the present invention;

FIG. 4 is a circuit diagram of the touch-control apparatus according to the embodiment of the present invention;

FIG. 5 is a schematic view of another touch-control apparatus according to the embodiment of the present invention;

FIG. 6 is a flow chart of a detecting method of the touch-control apparatus according to the embodiment of the present invention;

FIG. 7 is a waveform of the touch-control apparatus according to a first embodiment of the present invention;

FIG. 8 is a waveform of the touch-control apparatus according to a second embodiment of the present invention; and

FIG. 9 is a waveform of the touch-control apparatus according to a third embodiment of the present invention.

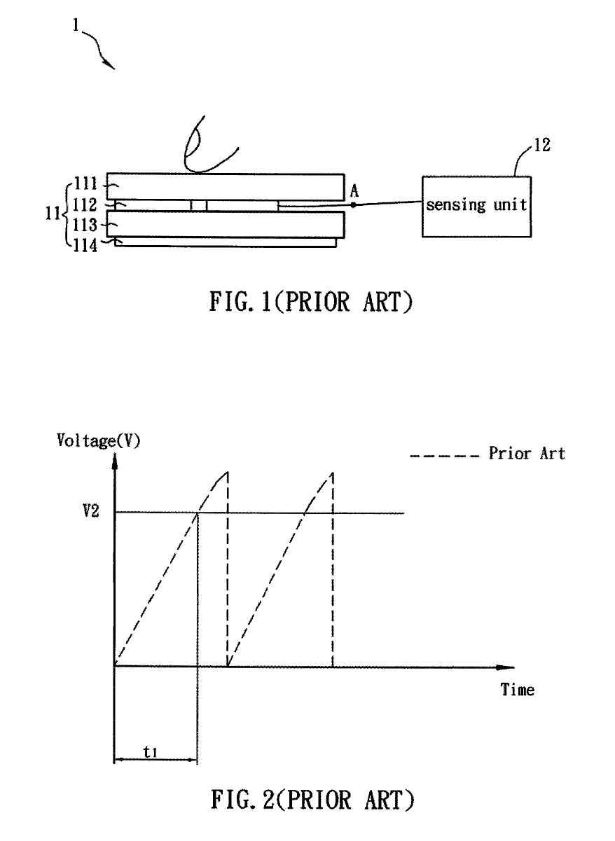

### DETAILED DESCRIPTION OF THE INVENTION

The present invention will be apparent from the following detailed description, which proceeds with reference to the accompanying drawings, wherein the same references relate to the same elements.

The touch-control apparatus of the present invention can cooperate with a display apparatus (not shown), such as a LCD display apparatus, an OLED display apparatus or an e-paper display apparatus.

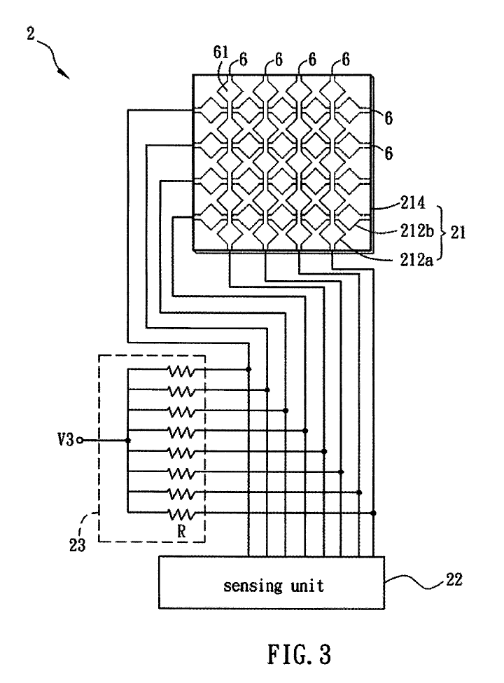

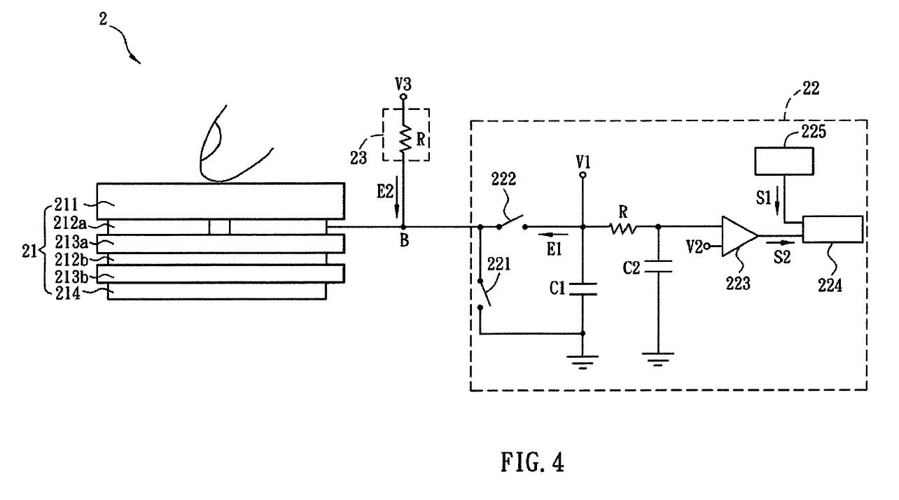

FIG. 3 is a schematic view of a touch-control apparatus according to an embodiment of the present invention, and FIG. 4 is a circuit diagram of the touch-control apparatus. With reference to FIGS. 3 and 4, a touch-control apparatus 2 according to an embodiment of the present invention includes a touch-control unit 21, a sensing unit 22 and an auxiliary voltage supplying unit 23, which is electrically connected with the touch-control unit 21 and the sensing unit 22.

The touch-control unit 21 has a touch-control substrate 211, at least one touch-control electrode layer, two insulating layers 213a and 213b, and an electrical shielding layer 214. The touch-control substrate 211, which is made of glass or a plastic material, can protect the internal electronic elements and sense the press actions. The touch-control electrode layer is disposed on one surface of the touch-control substrate 211. In this embodiment, the touch-control unit 21, for example, has two touch-control electrode layers, i.e. a first touch-control electrode layer 212a and a second touch-control electrode layer 212b. Each of the first and second touch-control electrode layers 212a and 212b includes a plurality of sensing conductive bars 6, and the sensing conductive bars 6 of the first touch-control electrode layer 212a are perpendicular to those of the second touch-control electrode layer 212b. The sensing electrodes 61 of the sensing conductive bars 6 of the first and second touch-control electrode layers 212a and 212b can be rhombic, square, circular, elliptic, polygonal or irregular. In the current embodiment, the sensing electrodes 61 are rhombic for example. Moreover, the first and second touch-control electrode layers 212a and 212b can be transparent thin-film conductive layers. The insulating layer 213a is disposed between the first and second touch-control electrode layers 212a and 212b, and the insulating layer 213b is disposed between the second touch-control electrode layer 212b and the electrical shielding layer 214. In the embodiment, the electrical shielding layer 214 is made of an electrical conductive material such as an ITO (indium tin oxide) thin film. To be noted, the touch-control apparatus 2 may be not configured with the electrical shielding layer 214 depending on different designs, and the touch-control apparatus 2 of this embodiment is configured with the electrical shielding layer 214 indeed.

The sensing unit 22 is electrically connected with the first and second touch-control electrode layers 212a and 212b of the touch-control unit 21. In more detailed, the sensing unit 21 is electrically connected with the sensing conductive bars 6 of the first and second touch-control electrode layers 212a and 212b. Referring to FIG. 4, several aspects of the sensing unit will be described hereinbelow, wherein some elements (e.g. the auxiliary voltage supplying unit) are omitted for concise purpose, and the auxiliary voltage supplying unit 23 is coupled to, for example, only one of the sensing conductive bars 6 in the following cases. In this embodiment, the sensing unit 22 receives a power signal V1, so that it then outputs a charging signal E1, which is a DC signal, to the touch-control electrode layers 212a and 212b. As shown in FIG. 4, the sensing unit 22 has a first switch 221, a second switch 222, a resistor R, two capacitors C1 and C2, a comparator 223 and a timer 224. One terminal of the first switch 221 and one terminal of the second switch 222 are coupled with the touch-control electrode layer 212a, the other terminal of the first switches 221 is grounded, and the other terminal of the second switch 222 is coupled with the auxiliary voltage supplying unit 23. Thus, the first and second switches 221 and 222 can control the direction of the charging signal E1. If the charging signal E1 should not be transmitted to the touch-control unit 21, the first and second switches 221 and 222 are both open circuited, so that the charging signal E1 can not be transmitted from the sensing unit 22 to the touch-control unit 21. Two terminals of the resistor R are coupled with the capacitors C1 and C2, respectively, and the resistor R and the capacitor C2 can form a low-pass filter. An input terminal of the comparator 223 is coupled with one terminal of the resistor R and one terminal of the capacitor C2, and another input terminal of the comparator 223 is used to receive a reference voltage V2. An input terminal of the timer 224 is coupled with an output terminal of the comparator 223, and another input terminal thereof is coupled with an oscillator 225. The oscillator 225 can output a signal S1, which is a clock signal, to the timer 224. To be noted, the structure aspect of the sensing unit 22 is used for illustration only and is not to limit the scope of the present invention.

With reference to FIG. 3 again, the auxiliary voltage supplying unit 23 is electrically connected with the sensing unit 22 and the touch-control electrode layers 212a and 212b of the touch-control unit 21. In more specific, the auxiliary voltage supplying unit 23 is electrically connected with the sensing conductive bars 6 of the sensing unit 22 and the touch-control electrode layers 212a and 212b. In this embodiment, the auxiliary voltage supplying unit 23 receives an auxiliary power signal V3 and then outputs an auxiliary charging signal E2 to the touch-control electrode layers 212a and 212b. Herein, the auxiliary power signal V3 and the auxiliary charging signal E2 are both DC signals. In addition, the auxiliary voltage supplying unit 23 includes at least one resistor R for electrically connecting with the sensing unit 22 and the touch-control electrode layers 212a and 212b. In the current embodiment, the auxiliary voltage supplying unit 23 includes a plurality of resistors R, each of which is electrically connected with the sensing conductive bars 6 of the first and second touch-control electrode layers 212a and 212b. To be noted, the charging signal E1 and the auxiliary charging signal E2 can be adjusted according to different designs.

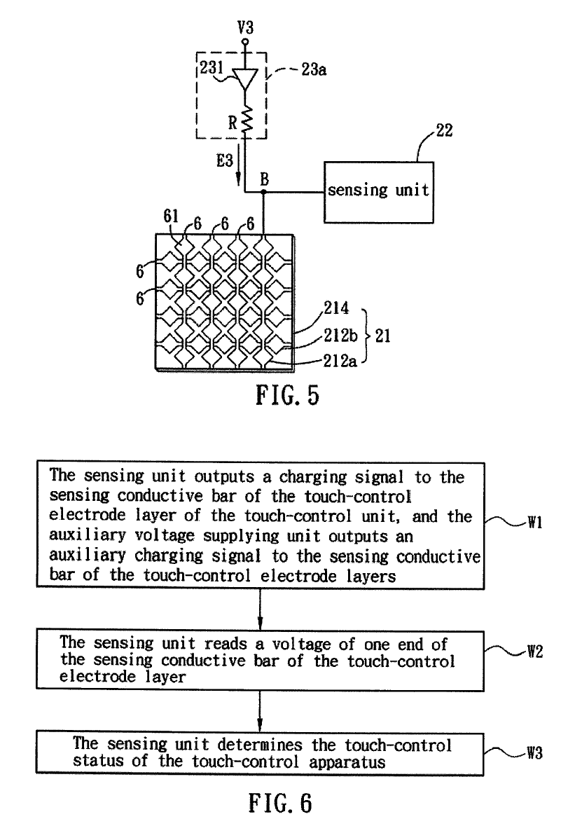

FIG. 5 is a schematic view of another touch-control apparatus according to the embodiment of the present invention. Referring to FIG. 5, an auxiliary voltage supplying unit 23a may further include an amplifier 231 coupled with the resistor R. In this embodiment, the amplifier 231 is coupled with one sensing conductive bar 6 of the first touch-control electrode layer 212a for illustration only. The amplifier 231 can amplify the received auxiliary power signal V3, and then the auxiliary power signal V3 is stepped down by the resistor R so as to output an auxiliary charging signal E3 to the first touch-control electrode layer 212a.

As shown in FIG. 6, the present invention further discloses a detecting method of a touch-control apparatus, which includes a touch-control unit, a sensing unit and an auxiliary voltage supplying unit. The detecting method includes the steps W1 to W4. The details and flow of the detecting method of the touch-control apparatus of the present invention will be described hereinafter with reference to FIGS. 3, 4 and 6.

In the step W1, the sensing unit 22 receives a power signal V1 and then outputs a charging signal E1 to the touch-control electrode layers 212a and 212b of the touch-control unit 21 for charging the capacitances of the sensing conductive bars 6 of the touch-control electrode layers 212a and 212b. In addition, the step W1 the auxiliary voltage supplying unit 23 further receives an auxiliary power signal V3, which is stepped down by a resistor R, and then the auxiliary voltage supplying unit 23 outputs an auxiliary charging signal E2 to the touch-control electrode layers 212a and 212b of the touch-control unit 21 for charging the capacitances of the sensing conductive bars 6 of the touch-control electrode layers 212a and 212b. Since the touch-control apparatus 2 reads the touch-control status by way of continuously scanning, the charging signal E1 and the auxiliary charging signal E2 can be transmitted to the to-be-detected sensing conductive bar 6 at the same time period or adjacent two time periods. In this case, the charging signal E1 and the auxiliary charging signal E2 are transmitted to one of the sensing conductive bars 6 of the first touch-control electrode layer 212a.

In the step W2, the sensing unit 22 reads a voltage of one end B of the sensing conductive bar 6 of the first touch-control electrode layer 212a. After passing through a low-pass filter consisting of the resistor R and capacitor C2, the voltage is transmitted to the input terminal of a comparator 223 of the sensing unit 22. Then, the comparator 223 can compare the read voltage with a reference voltage V2. If the read voltage is equal to the reference voltage V2, a signal S2 is then transmitted to a timer 224. In addition, an oscillator 225 outputs a signal S1, and the timer 224 starts counting according to the signal S1 when the charging signal E1 and the auxiliary charging signal E2 are inputted to the touch-control electrode layers 212a and 212b. When the voltage read by the comparator 223 is equal to the reference voltage V2, the comparator 223 transmits a signal S2 to the timer 224 to stop counting. Then, the sensing unit 22 can calculate to obtain a capacitance value according to the current flowing through the sensing conductive bar 6 during the counted time period. The obtained capacitance value and the charging time are in direct proportion, and the obtained capacitance value can represent the capacitance of the sensing conductive bar 6 or the sum of the capacitance of the sensing conductive bar 6 and the capacitance generated as the touch-control apparatus 2 is pressed.

In the step W3, the sensing unit 22 compares the detected capacitance value and the capacitance value as the touch-control apparatus 2 is not pressed to determine the touch-control status of the touch-control apparatus 2.

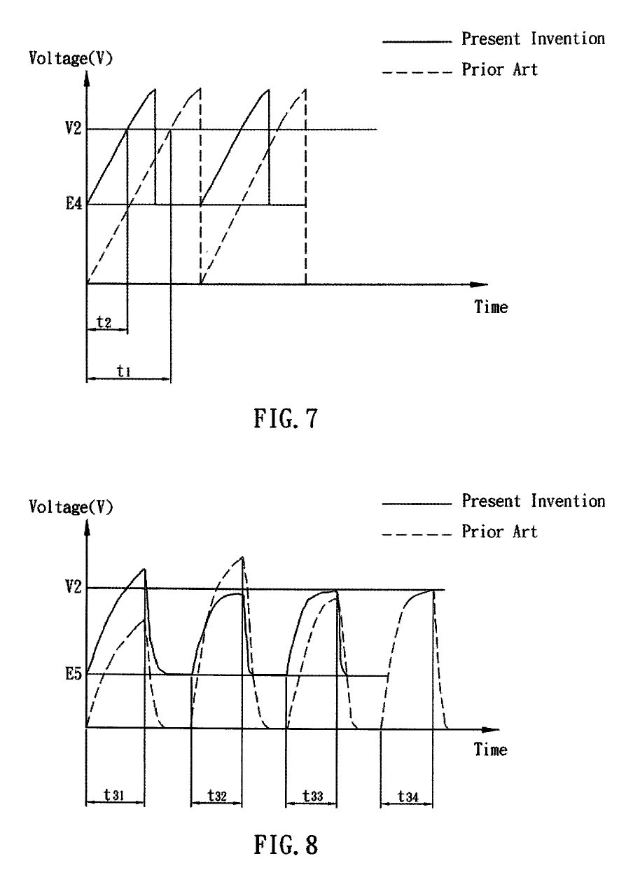

FIG. 7 is a waveform diagram of a touch-control apparatus according to a first embodiment of the present invention, wherein the solid line represents the waveform of the touch-control apparatus of the present invention and the dotted line represents the waveform of the conventional touch-control apparatus. The waveform diagram is obtained by measuring the voltage of one end of the sensing conductive bar of the touch-control electrode layer. In the present embodiment, the auxiliary voltage supply unit of the touch-control apparatus outputs an auxiliary charging signal E4 to the sensing conductive bar of the touch-control electrode layer of the touch-control unit in advance so as to provide a pre-determined level to the sensing conductive bar, and then the sensing unit outputs the charging signal to the sensing conductive bar of the touch-control electrode layer of the touch-control unit. Accordingly, the capacitance of the to-be-detected sensing conductive bar can be charged. After that, the sensing unit detects a time period for the end when the voltage reaches the reference voltage V2 so as to calculate a capacitance value of the sensing conductive bar based on the detected time period. Then, the touch-control status can be determined according to the calculated capacitance value. As shown in FIG. 7, the conventional touch-control apparatus needs the time period t₁ to charge the voltage of the sensing conductive bar to the reference voltage V2, and the touch-control apparatus of the present embodiment needs the time period t₂, which is shorter than the time period t₁, to do the same thing. Thus, the sensing speed of the touch-control apparatus of the present invention is increased.

FIG. 8 is a waveform diagram of a touch-control apparatus according to a second embodiment of the present invention, wherein the solid line represents the waveform of the touch-control apparatus of the present invention and the dotted line represents the waveform of the conventional touch-control apparatus. The waveform diagram is obtained by measuring the voltage of one end of the sensing conductive bar of the touch-control electrode layer. In the present embodiment, the auxiliary voltage supply unit of the touch-control apparatus outputs an auxiliary charging signal E5 to the sensing conductive bar of the touch-control electrode layer of the touch-control unit in advance so as to provide a pre-determined level to the sensing conductive bar, and then the sensing unit outputs the charging signal to the sensing conductive bar of the touch-control electrode layer of the touch-control unit. Accordingly, the capacitance of the to-be-detected sensing conductive bar can be charged. The touch-control apparatus of the present embodiment charges the capacitance during a predetermined time period so as to precisely charge the capacitance to the reference voltage V2. If the voltage of the charged capacitance is greater than or less than the reference voltage V2 during this predetermined time period, a current valve provided by the sensing unit for the next charging procedure will be modified. In addition, the sensing unit detects the voltage of the end to obtain the current value therethrough provided by the sensing unit when the detected voltage reaches a reference voltage V2 during the predetermined time period. Then, a capacitance value of the sensing conductive bar can be calculated based on the current value. Thus, the touch-control status can be determined according to the capacitance value of the sensing conductive bar. As shown in FIG. 8, during a first time period t₃₁, the auxiliary voltage supplying unit of the second embodiment outputs the auxiliary charging signal E5 to the sensing conductive bar of the touch-control electrode layer for providing a pre-determined level to the sensing conductive bar of the touch-control electrode layer, and the sensing unit outputs a charging signal with a first level to the sensing conductive bar of the touch-control electrode layer. However, during the first time period t₃₁, the charging signal and the auxiliary charging signal E5 can not precisely increase the voltage of the to-be-detected sensing conductive bar to reach the reference voltage V2, so the charging signal must be adjusted. During the second time period t₃₂, the auxiliary voltage supplying unit continuously outputs the auxiliary charging signal E5 to the sensing conductive bar of the touch-control electrode layer for providing the pre-determined level to the touch-control electrode layer, and the sensing unit outputs a charging signal with a second level to the sensing conductive bar of the touch-control electrode layer. However, during the second time period t₃₂, the capacitance of the to-be-detected sensing conductive bar is over-charged by the charging signal and the auxiliary charging signal E5, so the voltage thereof is higher than the reference voltage V2. Thus, the charging signal must be adjusted again. During the third time period t₃₃, the auxiliary voltage supplying unit continuously outputs the auxiliary charging signal E5 to the sensing conductive bar of the touch-control electrode layer for providing the pre-determined level to the touch-control electrode layer, and the sensing unit outputs a charging signal with a third level to the sensing conductive bar of the touch-control electrode layer. During the third time period t₃₃, the capacitance of the to-be-detected sensing conductive bar is precisely charged by the charging signal and the auxiliary charging signal E5 to reach the reference voltage V2. As shown in FIG. 8, the conventional touch-control apparatus reaches the reference voltage V2 during the fourth time period t₃₄, which means that the conventional touch-control apparatus needs four charging procedures to make the capacitance of the sensing conductive bar reach the reference voltage V2. In contrast, the touch-control apparatus of the present invention can make the capacitance of the sensing conductive bar precisely reach the reference voltage V2 by three charging procedures. Thus, the touch-control apparatus of the present invention can reach the reference voltage V2 with shorter time than the conventional one, so that the sensing speed of the touch-control apparatus of the present invention is increased.

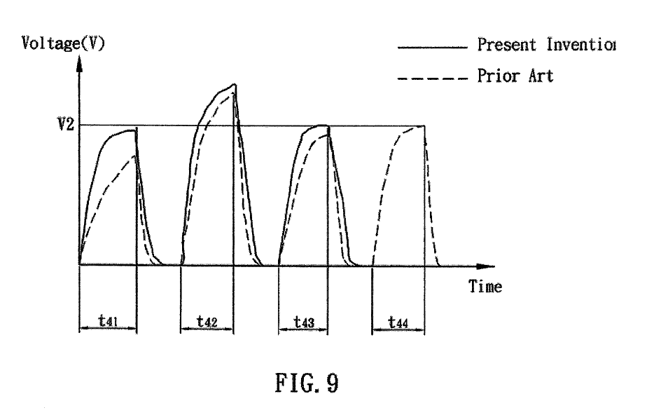

FIG. 9 is a waveform diagram of a touch-control apparatus according to a third embodiment of the present invention, wherein the solid line represents the waveform of the touch-control apparatus of the present invention and the dotted line represents the waveform of the conventional touch-control apparatus. The waveform diagram is obtained by measuring the voltage of one end of the touch-control electrode layer. In the present embodiment, the auxiliary voltage supply unit and the sensing unit of the touch-control apparatus output an auxiliary charging signal and a charging signal to the sensing conductive bar of the touch-control electrode layer of the touch-control unit, respectively and simultaneously, so as to charge the capacitance of the to-be-detected sensing conductive bar. Since the auxiliary charging signal and the charging signal are simultaneously transmitted to the sensing conductive bar of the touch-control electrode layer, the charging speed thereof can be accelerated. The touch-control apparatus of the present embodiment charges the capacitance during a predetermined time period so as to precisely charge the capacitance of the sensing conductive bar to the reference voltage V2. If the voltage of the charged capacitance is greater than or less than the reference voltage V2 during this time period, the voltage for the next charging procedure will be modified, so that the voltage of the capacitance can precisely reach the reference voltage V2. In addition, the sensing unit detects the voltage of the end to obtain a current value therethrough simultaneously provided by the auxiliary voltage supplying unit and the sensing unit when the detected voltage reaches a reference voltage V2 during the predetermined time period. Then, a capacitance value of the sensing conductive bar can be calculated based on the current value. Thus, the touch-control status can be determined according to the capacitance value of the sensing conductive bar. As shown in FIG. 9, during a first time period t₄₁, the auxiliary voltage supplying unit and the sensing unit of the third embodiment respectively output an auxiliary charging signal with a first level and a charging signal to the sensing conductive bar of the touch-control electrode layer, simultaneously. However, during the first time period t₄₁, the charging signal and the auxiliary charging signal can not precisely increase the voltage of the capacitance of the to-be-detected sensing conductive bar to reach the reference voltage V2, so the auxiliary charging signal must be adjusted. During the second time period t₄₂, the auxiliary voltage supplying unit and the sensing unit respectively output an auxiliary charging signal with a second level and a charging signal to the touch-control electrode layer, simultaneously. However, during the second time period t₄₂, the capacitance of the to-be-detected sensing conductive bar is over-charged by the charging signal and the auxiliary charging signal, so the voltage thereof is higher than the reference voltage V2. Thus, the auxiliary charging signal must be adjusted again. During the third time period t₄₃, the auxiliary voltage supplying unit and the sensing unit respectively output an auxiliary charging signal with a third level and a charging signal to the sensing conductive bar of the touch-control electrode layer, simultaneously. During the third time period t₄₃, the capacitance of the to-be-detected sensing conductive bar is precisely charged by the charging signal and the auxiliary charging signal to reach the reference voltage V2. As shown in FIG. 9, the conventional touch-control apparatus reaches the reference voltage V2 during the fourth time period t₄₄, which means that the conventional touch-control apparatus needs four charging procedures to make the capacitance of the sensing conductive bar reach the reference voltage V2. In contrast, the touch-control apparatus of the present invention can make the capacitance of the sensing conductive bar precisely reach the reference voltage V2 by three charging procedures. Thus, the touch-control apparatus of the present invention can reach the reference voltage V2 with shorter time than the conventional one, so that the sensing speed of the touch-control apparatus of the present invention is increased.

In summary, the touch-control apparatus of the present invention has a sensing unit for outputting the charging signal to the sensing conductive bar of the touch-control electrode layer of the touch-control unit and an auxiliary voltage supplying unit for outputting the auxiliary charging signal to the sensing conductive bar of the touch-control electrode layer, respectively or simultaneously. Thus, the capacitances of the touch-control unit can reach the desired reference voltage much faster. Since the capacitance value and the charging time are in direct proportion, the sensing unit can determine whether the touch-control apparatus is pressed according to the charging time. Accordingly, the touch-control apparatus of the present invention can increase the charging speed of the capacitances of the sensing conductive bar, so that the sensing efficiency of the touch-control apparatus can be enhanced.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A touch-control apparatus, comprising:
a touch-control unit comprising a touch-control substrate and at least one touch-control electrode layer disposed on a surface of the touch-control substrate;
a sensing unit electrically connected with the touch-control electrode layer of the touch-control unit and outputting a charging signal to a sensing conductive bar of the touch-control electrode layer according to a power signal; and
an auxiliary voltage supplying unit electrically connected with the sensing unit and the touch-control electrode layer of the touch-control unit for outputting an auxiliary charging signal to the sensing conductive bar.

2. The touch-control apparatus according to claim 1, wherein the auxiliary voltage supplying unit comprises a resistor electrically connected with the sensing unit and the touch-control electrode layer.

3. The touch-control apparatus according to claim 2, wherein the auxiliary voltage supplying unit further comprises an amplifier coupled with the resistor.

4. The touch-control apparatus according to claim 1, wherein the auxiliary voltage supplying unit and the sensing unit transmit the auxiliary charging signal and the charging signal, respectively and simultaneously, to the sensing conductive bar.

5. The touch-control apparatus according to claim 1, wherein the auxiliary charging signal provides a pre-determined level to the sensing conductive bar.

6. The touch-control apparatus according to claim 1, wherein the touch-control unit further comprises at least one insulation layer and an electrical shielding layer, and the insulation layer is disposed between the touch-control electrode layer and the electrical shielding layer.

7. The touch-control apparatus according to claim 6, wherein the material of the electrical shielding layer is an electrical conductive material, and the touch-control electrode layer is a transparent thin-film electrical conductive layer.

8. The touch-control apparatus according to claim 1, wherein the sensing unit comprises a comparator and a timer, and an input terminal of the timer is coupled with an output terminal of the comparator.

9. The touch-control apparatus according to claim 1, wherein the sensing unit comprises a first switch and a second switch, and one terminal of the first switch and one terminal of the second switch are coupled with the touch-control electrode layer.

10. The touch-control apparatus according to claim 1, wherein the sensing unit comprises a resistor and at least one capacitor electrically connected with each other.

11. The touch-control apparatus according to claim 1, wherein the auxiliary charging signal is a DC signal and the charging signal is a DC signal.

12. A detecting method of a touch-control apparatus, the touch-control apparatus comprising a touch-control unit, a sensing unit and an auxiliary voltage supplying unit, the detecting method comprising steps of:
outputting a charging signal to a sensing conductive bar of a touch-control electrode layer of the touch-control unit according to a power signal by the sensing unit;
outputting an auxiliary charging signal to the sensing conductive bar by the auxiliary voltage supplying unit; and
reading a voltage of an end of sensing conductive bar by the sensing unit.

13. The detecting method according to claim 12, further comprising steps of:
transmitting the read voltage to an input terminal of a comparator; and
comparing the read voltage and a reference voltage by the comparator so as to output a signal to a timer.

14. The detecting method according to claim 13, further comprising steps of:
outputting a signal to the timer by an oscillator; and
counting by the timer according to the signal outputted by the oscillator and the signal outputted by the comparator.

15. The detecting method according to claim 12, wherein the auxiliary voltage supplying unit and the sensing unit provide the auxiliary voltage signal and the charging signal, respectively and simultaneously, to the sensing conductive bar.

16. The detecting method according to claim 15, further comprising a step of:
detecting the voltage of the end by the sensing unit to obtain a current value therethrough simultaneously provided by the auxiliary voltage supplying unit and the sensing unit when the detected voltage reaches a reference voltage during a predetermined time period so as to calculate a capacitance value of the sensing conductive bar based on the current value.

17. The detecting method according to claim 12, wherein the step of outputting the auxiliary charging signal to the sensing conductive bar by the auxiliary voltage supplying unit is prior to the step of outputting the charging signal to the sensing conductive bar so as to provide a pre-determined level to the sensing conductive bar.

18. The detecting method according to claim 17, further comprising a step of
detecting a time period for the end by the sensing unit when the voltage reaches a reference voltage so as to calculate a capacitance value of the sensing conductive bar based on the time period.

19. The detecting method according to claim 17, further comprising a step of:
detecting the voltage of the end by the sensing unit to obtain a current value therethrough provided by the sensing unit when the detected voltage reaches a reference voltage during a certain time period so as to calculate a capacitance value of the sensing conductive bar based on the current value.

20. The detecting method according to claim 12, wherein the auxiliary charging signal is a DC signal and the charging signal is a DC signal.
